(19) United States
(12) Patent Application Publication
(10) Pub. No.: US 2007/0256302 A1
(43) Pub. Date: Nov. 8, 2007

(54) Rotary electric shaver

(75) Inventor: Masaki Okabe, Matsumoto (JP)

Correspondence Address: QUINN EMANUEL;KODA & ANDROLIA, 865 S. FIGUEROA STREET, 10TH FLOOR, LOS ANGELES, CA, 90017, US

(73) Assignee: IZUMI PRODUCTS COMPANY

(21) Appl. No.: 11/800,697

(22) Filed: May 7, 2007

(30) Foreign Application Priority Data
May 8, 2006 (JP) 2006-129118

(51) Int. Cl. B26B 19/14

(52) U.S. Cl. 30/43.6

(57) ABSTRACT

A rotary electric shaver including a shaver main body; a motor installed in the shaver main body; and a plurality of outer cutter units detachably provided on the shaver main body, each of the outer cutter units including an outer cutter and an inner cutter which is rotated by the motor and rotate while sliding against the inner surface of the outer cutter are, and in this shaver, each of the outer cutter unit includes a cutter frame on which the outer cutter is mounted at a top end thereof, and this cutter frame is swingable in any direction, and thus the outer cutter units are swingable independently of each other.

### BACKGROUND OF THE INVENTION

1. Field of the Invention

The present invention relates to a rotary electric shaver and more particularly to outer cutter units installed in a rotary electric shaver.

2. Description of the Related Art

FIGS. 8(a) and 8(b) are, respectively, a top view and a side view of outer cutters provided in a rotary electric shaver. In a so-called three-eye type rotary electric shaver, three outer cutters 10 each in a circular shape are provided in an outer cutter frame 12. The center positions of three outer cutters 10 are deployed so as to coincide with the positions of the apexes of an equilateral triangle as seen from above. In each of the outer cutters 10, a numerous number of slit openings 10a, which are for introducing whiskers (or hair) inside the outer cutter and oriented in the radial direction from the centers of the outer cutter, are provided in the circumferential direction.

As shown in FIG. 8(b), the outer cutters 10 are provided so that the shaving surfaces (or the outer top surfaces) thereof protrude slightly above the upper surface of the outer cutter frame 12. During shaving, the outer cutters 10 are pressed against the surface of the skin being shaved, and shaving is performed so that the hair introduced through the slit openings 10a is cut by the outer cutters 10 and inner cutters that rotate while sliding against the inner surfaces of the outer cutters 10. As seen from FIG. 8(a), a pressing surface 13 (diagonally hatched portion in FIG. 8(a)) is provided on the outer cutter frame 12 so that the three outer cutters 10 are interconnected in order to prevent the skin from being excessively pressed into the outer cutters 10 during shaving.

There are a number of methods for configuring the manner in which the outer cutters 10 are provided in the outer cutter frame 12. In one method, the outer cutters 10 are provided so that they can move up and down relative to the outer cutter frame 12, normally in a protruding position, but sinking in when pressed on (see, for instance, Japanese Patent Application Laid-Open (Kokai) No. 2001-755). In other methods, the outer cutters 10 are pivotally fastened to the outer cutter frame 12 so that they can tilt, the outer cutters 10 are supported so that they slide as over a spherical surface in the outer cutter frame 12 with the outer cutters being able to tilt in any direction, and further the outer cutter frame is divided into three tiltable rims so that the outer cutters tilt together with the rims (see, for instance, Japanese Patent Application Laid-Open (Kokai) No. 2004-283808).

In a conventional rotary electric shaver, the outer cutters 10 are configured so that they are movable relative to the outer cutter frame 12 in order to make it easier for the outer cutters 10 to follow the irregularities in the surface of the skin being shaved and to make it possible that the surface of the skin being shaved makes tight contact with the outer cutters to improve shaving efficiency, thus eliminating shaving misses, and enhancing the feeling of the shaving.

In a rotary electric shaver having a conventional configuration for supporting the outer cutters 10 in the outer cutter frame 12, however, the movable range of the outer cutters 10 is restricted by the outer cutter frame 12, and the outer cutters 10 are unable to adequately follow the surface of the skin being shaved.

FIGS. 9(a) and 9(b) show an explanatory diagram of the condition wherein a convex portion of the surface of the skin being shaved strikes the outer cutters 10. When the convex portion of the surface of the skin being shaved strikes the outer cutters 10, the outer cutters 10, as shown in FIG. 9(a), tilt inwardly. In such a case, as shown in FIG. 9(b), the area A in the center portion of the outer cutters 10 becomes the area that contributes to the shaving action. When, as seen from FIG. 10(a), a concave portion of the surface of the skin being shaved strikes the outer cutters 10, on the other hand, then the outer cutters 10 tilt outwardly, and, as shown in FIG. 10(b), the areas B on the outside of the outer cutters 10 contributes to the shaving action.

As seen from the above, with a conventional rotary electric shaver, there is a problem in that the contact area of the outer cutters that effect the shaving action changes greatly and is destabilized, depending on the irregularities of the surface of the skin being shaved; and there is also a problem in that the area where the surface of the skin being shaved and the outer cutter shaving surface make contact becomes small because the amount of movement in the outer cutters is restricted, so that shaving efficiency is impaired.

### BRIEF SUMMARY OF THE INVENTION

Accordingly, the object of the present invention devised in order to resolve such problems as described above, is to provide a rotary electric shaver in which it is possible to effect shaving with the outer cutters nicely following the shapes of the irregularities in the surface of the skin being shaved, in which it is made easy for the outer cutter shaving surfaces to make contact with the surface of the skin being shaved to improve shaving efficiency, and in which the feel of shaving is enhanced.

The above objects are accomplished by a unique structure of the present invention for a rotary electric shaver comprising a shaver main body, a motor installed in the shaver main body, and a plurality of outer cutter units detachably provided on the shaver main body, each of the outer cutter units including an outer cutter and an inner cutter which is rotationally driven by the motor to rotate while sliding against the inner surface of the outer cutter; and in this structure,
each of the outer cutter unit includes a cutter frame with the outer cutter mounted at a top end thereof and this cutter frame is swingable and is detachably provided at matching positions where the outer cutter units are respectively deployed on the shaver main body; and
the outer cutter units provided on the shaver main body are swingable independently of each other.

In the present invention, the outer cutter units are deployed on the top part of the shaver main body so as to be at positions of apexes of an equilateral triangle as seen from above in a so-called three-eye type rotary electric shaver.

In the present invention, the outer cutters are provided at the tops of the swingable cutter frames so as to be movable and so that the shaving surfaces are urged by upwardly pushing springs so as always to protrude from the edge surface of the swingable cutter frames. As a result, the outer cutters tilt or move up and down relative to the swingable cutter frames, and the surface of the skin being shaved and outer cutter shaving surfaces of the outer cutters can make good contact more easily.

Furthermore, in the present invention, the inner cutters engage, so as to freely tilt, drive shafts that are linked to a drive mechanism installed in the shaver main body, so that the swingable cutter frames are allowed to swing or tilt while the rotational drive force is being transmitted from the drive shafts to the inner cutters.

Moreover, in the present invention, at the top part of the shaver main body, a supporting plate that shields the motor and drive mechanism from the outside is provided, and this supporting plate has an attachment portion or parts for detachably attaching the swingable cutter frames. Thus, the outer cutter units can be easily attached to or detached from the electric shaver main body.

In the present invention, moreover, the swingable cutter frame can take several different configurations. In one type, the cutter frame main body is formed in a cylindrical shape, and slits are provided so as to open at right angles in the axial direction at a plurality of different positions in the axial direction of the cutter frame main body, and they are open (or face) in mutually different directions at uniform locations in the circumferential direction of the cutter frame main body; and in another type, the cutter frame main body is formed in a substantially cylindrical shape, and a slit is provided the cutter frame main body so as to open in a shape that makes a plural number of turns in a spiral shape. Furthermore, the intermediate part in the axial direction of the cutter frame main body can be formed in a bellows having elasticity; and in addition, the cutter frame main body can be comprised of two cutter frame sections that are divided in the axial direction of the cutter frame main body, and the cutter frame sections are linked by elastic members.

In the present invention, moreover, in the interior of the cutter frame main body, a stopper can be provided for restricting the compression position of the swingable cutter frame, so that whenever a pressuring force acts on the swingable cutter frame, the swingable cutter frame is prevented from deforming excessively, providing a nice shaving feel.

As seen from the above, in the rotary electric shaver according to the present invention, the outer cutter units having the outer cutters attached to swingable cutter frames are provided so that they are swingable independently for each outer cutter. Accordingly, when the outer cutters are brought to come into contact with the surface of the skin to be shaved, the outer cutter units swing or tilt so as to follow the shape of the surface of the skin or the positions in contact due to the actions of the swingable cutter frames, and shaving is performed with the outer cutter shaving surfaces nicely and snugly making contact with the surface of the skin being shaved. The outer cutter units can make their moves independently according to the shape of the surface of the skin being shaved or to the pressing force, and the outer cutter shaving surfaces make contact nicely and snugly with the surface of the skin being shaved at every shaving position. Accordingly, efficient shaving is made possible, shaving misses are eliminated, and the feel of shaving is enhanced.

### BRIEF DESCRIPTION OF THE SEVERAL VIEWS OF THE DRAWINGS

FIG. 1 is a front elevational view of the entire configuration of the rotary electric shaver according to one embodiment of the present invention;

FIG. 2 is a front elevation thereof with the outer cutter units separated from the shaver main body;

FIG. 3(a) is a top view of the shaver of FIG. 1, and FIG. 3(b) is a cross-sectional view thereof taken along the line 3b-3b in FIG. 3(a), with one of the outer cutter unit (right side outer cutter unit) omitted;

FIG. 4 shows the cross-section of the outer cutter units and inner cutter drive mechanism;

FIG. 5(a) illustrates an outer cutter frame of one of the outer cutter unit, and FIGS. 5(b) through 5(d) are cross-sectional views taken along, respectively, the lines 5b-5b, 5c-5c and 5d-5d;

FIGS. 6(a) through 6(c) illustrate how the outer cutter units and the surface of the skin being shaved contact each other;

FIGS. 7(a) through 7(f) respectively show a set of the front and vertical cross-section of the swingable cutter frames used in the outer cutter units of the present invention;

FIGS. 8(a) and 8(b) shows conventional outer cutters, FIGS. 8(a) being a top view thereof, and 8(b) being a side view thereof;

FIGS. 9(a) and 9(b) illustrate the manner of action of the outer cutters in a conventional rotary electric shaver, FIG. 9(a) being a side view thereof, and 9(b) being a top view thereof; and

FIGS. 10(a) and 10(b) illustrate the manner of action of the outer cutters in a conventional rotary electric shaver, FIG. 10(a) being a side view thereof, and 10(b) being a top view thereof.

### DETAILED DESCRIPTION OF THE INVENTION

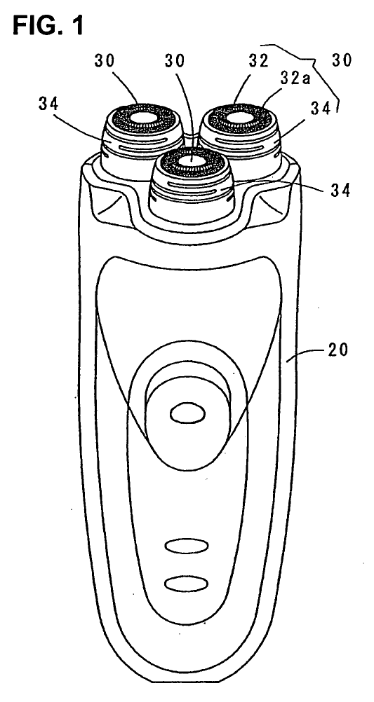

FIG. 1 shows the entire configuration of one embodiment of the rotary electric shaver according to the present invention. The electric shaver in this embodiment includes three outer cutter units 30 that are deployed at the top part of a shaver main body 20 of the electric shaver. Each outer cutter unit 30 comprises an outer cutter 32, a swingable cutter frame 34 for supporting the outer cutter 32, and an inner cutter that is rotationally driven so as to slide against the inner surface of the outer cutter 32.

The shape of the outer cutter 32 is the same as that of the outer cutters employed in conventional rotary electric shavers. In other words, the outer cutter 32 is formed in a circular shape and is provided in the circumferential direction with a multiplicity of slit openings 32a for the introducing hair into the outer cutter.

In the rotary electric shaver of the shown embodiment, separate swingable cutter frames 34 are provided for each one of the outer cutters 32. These swingable cutter frames 34 correspond to the outer cutter frame that supports the outer cutters in conventional rotary electric shavers. In other words, in conventional electric shavers, the outer cutters are provided in and supported by a common outer cutter frame; however, in the shown embodiment, each of the outer cutters 32 is provided with a separate swingable cutter frame 34.

The swingable cutter frames 34 are members that are formed in tubular shapes having flexibility, and the outer cutters 32 are mounted at the top ends of the swingable cutter frames 34. At the top part of the shaver main body 20, attachment portions are provided to which the swingable cutter frames 34 in an upright condition are detachably attached. These attachment portions are deployed so that the swingable cutter frames 34 are provided so as to be mutually adjacent and so that the center positions of the swingable cutter frames 34 are at the positions of the apexes of an equilateral triangle.

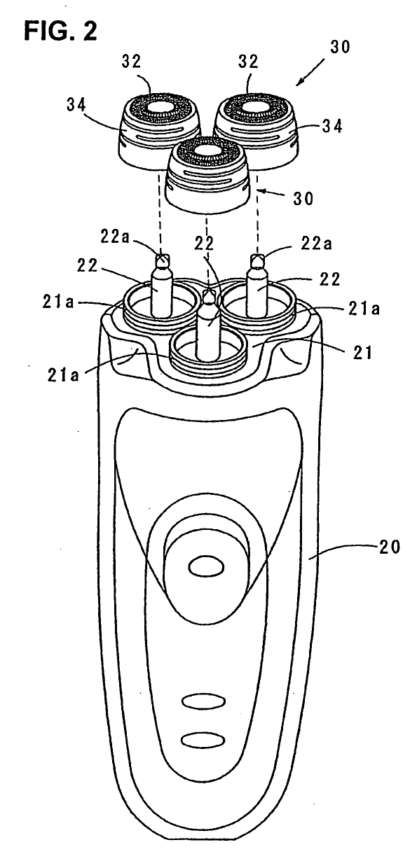

FIG. 2 shows the shaver with the outer cutter units 30 separated from the supporting plate 21 attached at the top part of the shaver main body 20. In the supporting plate 21, for the swingable cutter frame 34 attachment portions, external thread portions 21a for attaching the swingable cutter frames 34 thereon by screwing are provided at the positions of the apexes of the equilateral triangle, matching the positions where each of the swingable cutter frames 34 is provided. Thus, each of the external thread portions 21a makes a swingable cutter frame attachment portion. On the inner circumferential surfaces at the bottoms of the swingable cutter frames 34, internal threads are provided for engaging the external thread portions 21a. Each of the swingable cutter frames 34 is formed, on its inner circumferential surface near the bottom, with an internal thread for engaging the external thread portion 21a.

From the center of the area surrounded by each external thread portion 21a, a drive shaft 22, which is linked to a drive unit such as a motor or the like installed inside the shaver main body 20, extends out. These drive shafts 22 engage the inner cutters mounted in the outer cutter units 30 and act to rotationally drive the inner cutters. At the tip end of each drive shaft 22 is formed with an engagement end 22a that is engaged with the corresponding inner cutter.

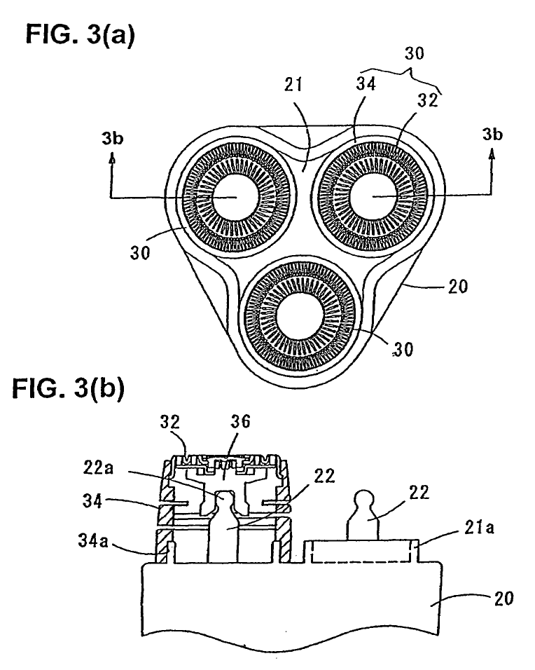

FIGS. 3(a) and 3(b) are respectively a top view showing the outer cutter units 30 attached to the supporting plate 21 and a cross-sectional view taken along the lines 3b-3b. As seen from FIG. 3(b), each one of the swingable cutter frames 34 is attached by screwing the internal thread 34a into the external thread portion 21a; and when the swingable cutter frame 34 is thus attached to the external thread portion 21a, the inner cutter 36 provided in the swingable cutter frame 34 engages the engagement end 22a of the driving shaft 22.

As seen from FIG. 3(a) and described above, the outer cutter units 30 are provided so that the centers of the outer cutters 32 are positioned at the apexes of an equilateral triangle. When the outer cutter 32 is attached to the swingable cutter frame 34, the shaving surface (or the outer top end surface) of the outer cutter 32 protrudes slightly, as seen from FIG. 3(b), above the edge surface of the swingable cutter frame 34.

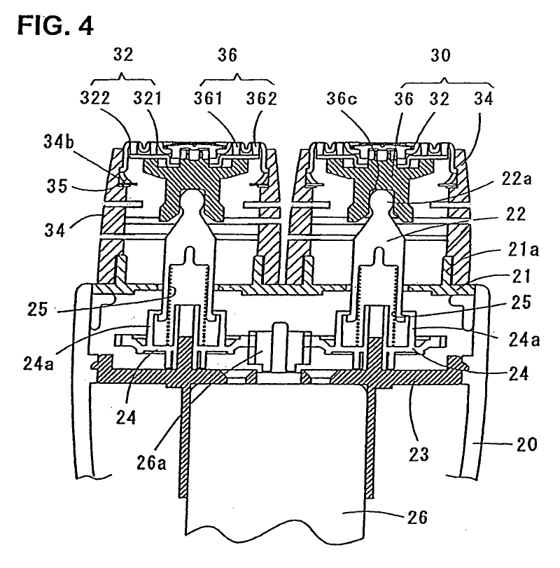

FIG. 4 shows the outer cutter units 30 attached to the supporting plate 21 along with the inner cutter drive mechanism.

Each of the outer cutters 32 is provided in a circumferential step groove 34b formed in the inner circumferential surface near the top end of the swingable cutter frame 34 and is urged upward by an upwardly pushing spring 35, so that the shaving surface thereof protrude out from the edge surface of the swingable cutter frame 34, and are supported so that they can move relative to the swingable cutter frames 34.

The inner cutters 36 are mounted so that cutter blades 361 and 362 slide against the inner surfaces of the outer cutters 32. In each outer cutter 32 of the shown embodiment, slit cutter blades 321 on the inner circumferential side and slit cutter blades 322 on the outer circumferential side are formed concentrically; and at the boundary portion between the inner and outer cutter blades 321 and 322, the outer cutter 32 takes a curved configuration so that the cross-sectional shape takes a concave groove. The inner and outer cutter blades 361 and 362 of the inner cutter 36 are in a bifurcated shape, and they respectively slide against the inner surface of the slit cutter blades 321 on the inner circumferential side of the outer cutter 32 and against the inner surface of the slit cutter blades 322 on the outer circumferential side of the outer cutter 32.

The bases of the inner cutters 36 are formed into engagement concaves 36c that are engaged with the engagement ends 22a formed at the tip ends of the drive shafts 22. The engagement concave 36c of each inner cutter 36 and the engagement end 22a of each drive shaft 22 are engaged with each other in a freely attachable and detachable manner; and when they are engaged mutually, the rotational drive force of the drive shaft 22 is transmitted through the engagement end 22a and the engagement concave 36c. Each inner cutter 36, when the engagement concave 36c and the engagement end 22a are engaged, is tiltable in any direction relative to the drive shaft 22.

The supporting plate 21 is provided so as to shield, from the outside, the motor 26 and other drive mechanisms installed inside the electric shaver main body 20, and the drive shafts 22 extending out from the supporting plate 21 are provided so that they are, at their root ends, linked to connecting gears 24 that are rotatably attached to the attachment plate 23 provided inside the shaver main body 20.

On each one of the connecting gears 24, a guide tube 24a, which is for supporting the drive shaft 22 movably in the axial direction and in a short tubular shape, is formed so that the guide tube 24a extends out in the axial direction. The drive shafts 22 are guide-supported at the base positions thereof by the guide tubes 24a so as to be movable in the axial direction, and they are engaged with the guide tubes 24a so as to integrally rotate.

Between the drive shafts 22 and the connecting gears 24, springs 25 are mounted so as to be urging means for urging the drive shafts 22 toward the outer cutter 32 or in a direction that makes them protrude out of the supporting plate 21. At the bases of the drive shafts 22, concavities are formed for accommodating one end of each of the springs 25, and the springs 25 are mounted so as to provide an elastic force between those concavities and the edge surfaces of the connecting gears 24.

The connecting gears 24 are provided so as to respectively match the positions where the outer cutter units 30 are deployed. The connecting gears 24 mesh with a gear 26a coupled to the output shaft of the motor 26 that is secured to the attachment plate 23.

The drive mechanism for the inner cutters 36 of the rotary electric shaver in the shown embodiment is substantially the same as the drive mechanism used in a conventional rotary electric shaver. In other word, in the shown embodiment, the drive shafts 22 are rotationally driven through the connecting gears 24 by the motor 26, and the inner cutters 36 engaging the drive shafts 22 are rotated, and thus the hair is cut by the outer cutters 32 and the rotating inner cutters 36. The drive shafts 22 are able to move in the axial direction by the springs 25; and when the swingable cutter frames 34 swing, extend, or contract, the drive shafts 22 follow the positions of the outer cutters 32 which are provided in the swingable cutter frames 34, so that shaving can be done with a condition that the inner cutters 36 slides against the outer cutters 32 being maintained. The drive shafts 22 can be made tilt comparatively greatly; and this can be done by setting the diameter of the through holes provided in the supporting plate 21 for the drive shafts 22 larger than the outer diameters of the drive shafts 22, and thus by setting a condition that the connecting gears 24 and the drive shafts 22 engage so as to be loose (or with sufficient play in between).

As described earlier, in the rotary electric shaver in the shown embodiment, the outer cutter units 30 are formed such that three outer cutters 32 are provided independently in the respective swingable cutter frames 34. The reason for configuring the outer cutter units 30 so as to be independent for each of the outer cutters 32 is twofold, namely so that the movable range of the outer cutter units 30, or, in other words, the amount of movement in the outer cutters 32, can be made larger than in a conventional rotary electric shaver, and so that each of the outer cutter units 30 can move independently without being restricted by another outer cutter unit 30.

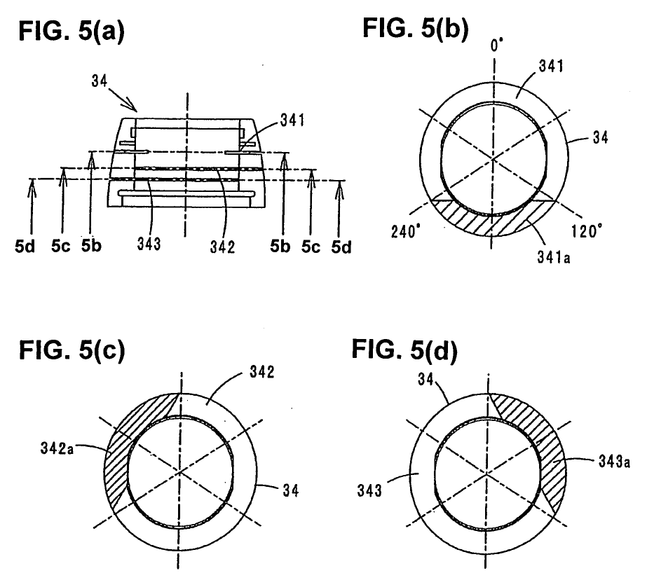

FIGS. 5(a) through 5(b) show the configuration of the swingable cutter frame 34 in the embodiment of the present invention. In this embodiment, the swingable cutter frame 34 is formed with slits. More specifically, slits are provided so as to be oriented perpendicularly to the axial direction of the cutter frames (so as to be horizontal slits) and caused to open from three mutually different directions in the circumferential direction of the axis of the cutter frame main body formed in a cylindrical shape.

FIG. 5(a) is a side view of the swingable cutter frame 34, showing that slits 341, 342, and 343 are formed at three levels in the axial direction of the swingable cutter frame 34. FIGS. 5(b), 5(c) and 5(d) are top views at the respective slit positions shown by 5b-5b, 5c-5c and 5d-5d FIG. 5(a). In each of FIG. 5(b), 5(c), and 5(d), the shaded areas 341a, 342a, and 343a are the connecting portions when the slits are opened in the cutter frame main body. In other words, the shaded areas 341a, 342a, and 343a are the solid portions of the cutter frame 34, and the remaining ring shaped empty areas are the slits 341, 342, and 343. The slits 341, 342, and 343 are provided so as to be opened from three different directions, so that the connecting (solid) portions 341a, 342a, and 343a are deployed so that each is displaced 120° about the axis of the swingable cutter frame 34. In this embodiment, the slits 341, 342, and 343 are provided so as to open at angles of about 240° in the circumferential direction. By providing the slits 341, 342, and 343 from three different directions in the circumferential direction of each swingable cutter frame 34 in this way, the swingable cutter frame 34 can swing in any direction.

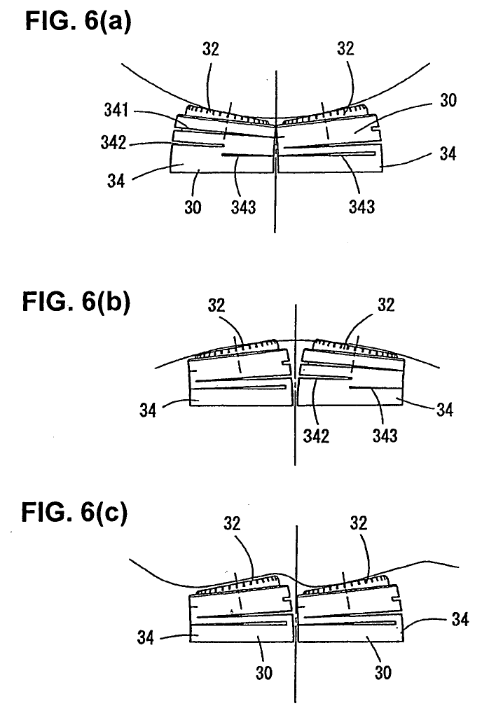

FIGS. 6(a) through 6(c) are explanatory diagrams showing the action of the outer cutter units 30 in the rotary electric shaver of the above-described embodiment. FIG. 6(a) shows the case that a convex portion of the surface of the skin being shaved is in contact with the outer cutter units 30, FIG. 6(b) shows the case that a concave portion of the surface of the skin being shaved is in contact with the outer cutter units 30, and FIG. 6(c) shows the case that an irregular portion of the surface of the skin being shaved is in contact with the outer cutter units 30.

In all of these cases, since the swingable cutter frames 34 of the outer cutter units 30 follow the shape of the surface of the skin being shaved and change the shape due to the fact that the swingable cutter frames 34 of the outer cutter units 30 are provided with slits and thus are able to make swing motions. Moreover, as a result of the swing motions of the cutter frames 34, the outer cutters 32 attached to the swingable cutter frames 34 tilt as seen from FIGS. 6(a) through 6(c) such that the entire shaving surfaces of the outer cutters 32 make contact with the surface of the skin being shaved. Since inner cutters 36, which are in contact with the inner surfaces of the outer cutters 32, engage the drive shafts 22 such that they can tilt in any direction, when the swingable cutter frames 34 swing (in any direction) during shaving, the engagement between the drive shafts 22 and the inner cutters 36 is maintained, and the contact of the inner cutters 36 with the outer cutters is also maintained.

During shaving, depending on the way the electric shaver is brought to contact the skin being shaved, the pressure acting on the outer cutters 32 fluctuates. Even in such cases, the swingable cutter frames 34 extend and contract so that the pressure fluctuations can be absorbed. Also, when the shaver is strongly pressed against the skin during shaving, the slits 341, 342, and 343 provided in the swingable cutter frames 34 are brought into in a compressed condition, and the swingable cutter frames 34 will not be compressed any further. Thus, shaving can be done with a prescribed pushing force. When the pressing force is made even stronger, the outer cutters 32 sink into the cutter frames 34 against the urging or pushing force of the upwardly pushing springs 35 provided between the outer cutters 32 and the cutter frame 34, and it is possible to prevent the skin from being injured.

In the embodiment described above, the horizontal slits 341, 342, and 343 are formed from three directions in the main body of the cutter frames 34 (or in the cutter frame main body) in order to allow the cutter frames 34 to swing in any direction. However, the configuration for making it possible for the swingable cutter frames 34 to swing is not limited to the embodiment described above. It is also possible, for example, to provide four or more slits in the swingable cutter frame 34 which are deployed evenly in the circumferential direction, and it is further possible to form the cutter frames 34 using a plastic or other flexible material or to suitably select the thickness of the cutter frame main body material.

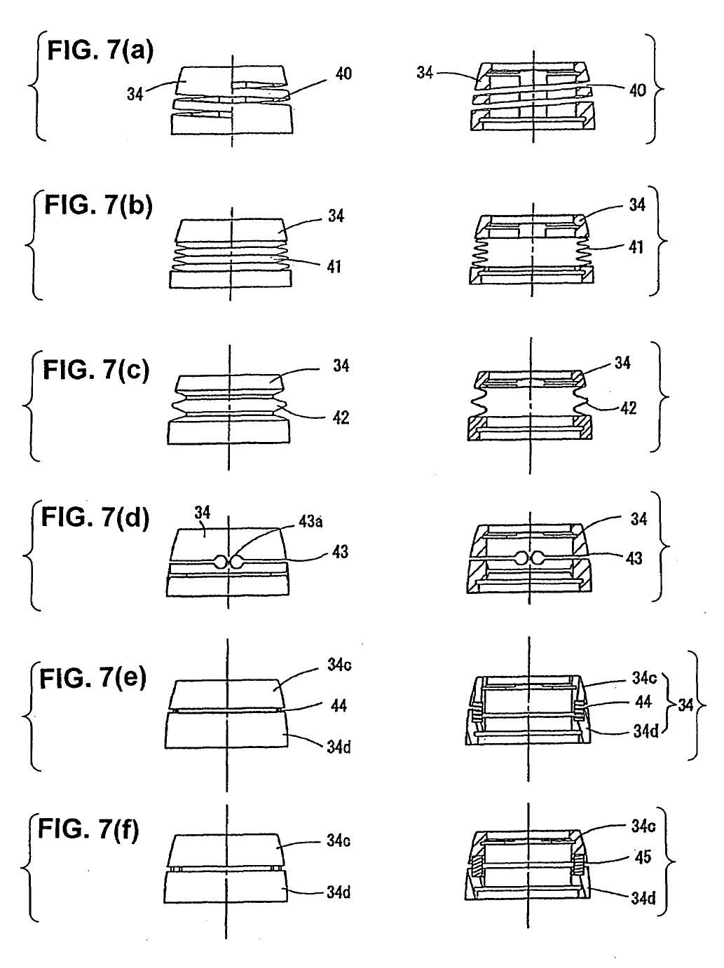

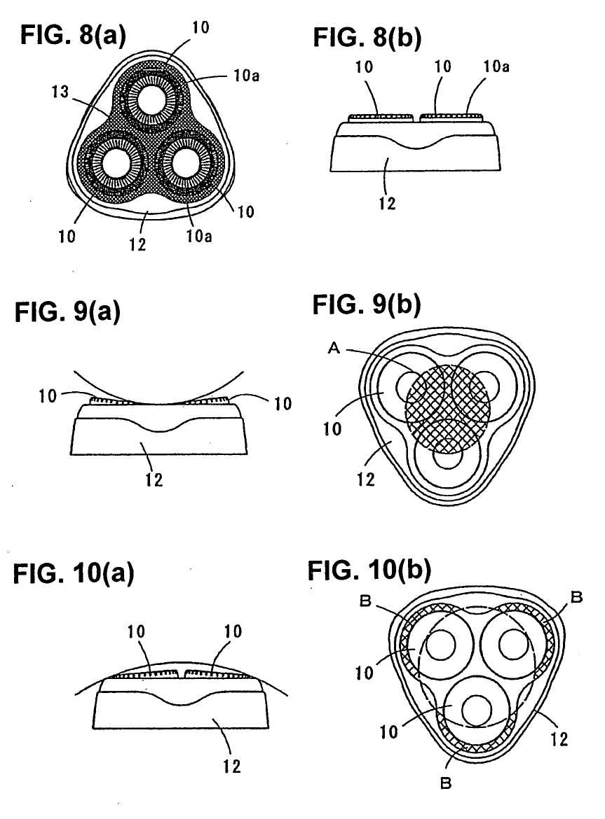

FIGS. 7(a) through 7(f) show other examples of swingable cutter frames 34. In each of the structures of FIGS. 7(a) to 7(f), the left side illustration is a front view of a swingable cutter frame 34, and the right side illustration shows a vertical cross section thereon.

In the structure of FIG. 7(a), a slit 40 is formed in the cutter frame main body of the swingable cutter frame 34 so that it opens in a spiral form. By forming the spiral slit 40 so that it has a plurality of turns (or at least one turn), the swingable cutter frame 34 can tilt in any direction.

In the structure of FIG. 7(b), a bellows part 41 made of thin material is formed in the cutter frame main body. This bellows part 41 is formed so as to exhibit a certain springiness. FIG. 7(c) also shows a structure in which the bellows part 42 is provided in the cutter frame main body; and in this structure of FIG. 7(c), the number of undulations in the bellows is less than that of the structure of FIG. 7(b). In the structures that include the bellows parts 41 and 42 provided in the cutter frame main bodies, the cutter frame 34 is comprised of a top cutter frame section and a bottom cutter frame section with the bellows parts 41 or 42 in between; and in such cutter frames, not only is it possible for the swingable cutter frames 34 to swing in any direction but also it is possible to prevent the cut hair (shaving debris) inside the swingable cutter frames 34 from being discharged to the outside.

FIG. 7(d) shows a structure in which a slit 43 is caused to make one turn about the cutter frame main body. In this structure, the length of the connected portion 43a at the ends of the slit 43 is set to be small, and the slit 43 is formed so that the swingable cutter frame 34 can swing in any direction with only a single slit.

FIG. 7(e) shows a structure in which the swingable cutter frame 34 is divided into two so as to be comprised of an upper cutter frame section 34c and a lower cutter frame section 34d, and these upper and lower cutter frame sections 34c and 34d are connected by springs 44 acting as an elastic body.

In FIG. 7(f), a structure that the upper and lower cutter frame sections 34c and 34d are connected by elastic rubber elements 45 is shown.

All of these swingable cutter frames 34 are swingable freely in any direction; and in like manner as the embodiment described earlier, the tightness of the contact between the surface of the skin being shaved and the outer cutters 32 can be enhanced.

In cases where, when a pressing force acts on the outer cutter units 30 during shaving and it is desired to restrict the swingable cutter frames 34 so that they do not swing or deform excessively, then it is preferable to provide stoppers on the inside of the cutter frame main bodies of the swingable cutter frames 34 so that the swingable cutter frames 34 do not deform more than a certain amount. One method for effecting this would be, for example, to provide a stopper of a cylindrical shape, shorter than the height (axial length) of the cutter frame main body of the swingable cutter frame 34, inside the cutter frame main body. With a cylindrical stopper inserted on the inside of the cutter frame main body, such an advantage is obtained that it is possible to prevent hair debris from being discharged from the slits.

In the embodiments described above, the swingable cutter frames 34 of the outer cutter units 30 are secured by screwing them into the external thread portions 21a of the supporting plate 21 installed in the shaver main body 20 of an electric shaver. However, the manner of providing the outer cutter units 30 to the supporting plate 21 includes, in addition to the above screw mounting, a male-female type coupling, a bayonet connection or the like. For cleaning the electric shaver, moreover, the outer cutter units 30 are removed (separated from the supporting plate 21), thus cleaning out the hair and other debris inside the outer cutter units 30, and also cleaning out the hair and other debris adhering to the supporting plate 21.

The present invention is described in the above on an electric rotary shaver having three outer cutter units; however, it should be noted that the present invention is applicable to an electric shaver that has a single outer cutter unit and two outer cutter units.

1. A rotary electric shaver comprising:
a shaver main body;
a motor installed in said shaver main body; and
a plurality of outer cutter units detachably provided on said shaver main body, each of said outer cutter units including an outer cutter and an inner cutter which is rotationally driven by said motor to rotate while sliding against an inner surface of said outer cutter, wherein:
each of said outer cutter unit includes a swingable cutter frame with said outer cutter mounted at a top end thereof, said swingable cutter frame being detachably provided at matching positions where said outer cutter units are respectively deployed on said shaver main body; and
said outer cutter units provided on said shaver main body are swingable independently of each other.

2. The rotary electric shaver according to claim 1, wherein said outer cutter units are respectively deployed on said shaver main body so as to be at positions of apexes of an equilateral triangle.

3. The rotary electric shaver according to claim 1, wherein said outer cutters are provided at the top ends of said swingable cutter frames so as to be movable and so that shaving surfaces thereof are urged by upwardly pushing springs so as to protrude from edge surfaces of said swingable cutter frames.

4. The rotary electric shaver according to claim 1, wherein said inner cutters are tiltably engaged with drive shafts which are linked to a drive mechanism installed in said shaver main body.

5. The rotary electric shaver according to claim 1, further comprising a supporting plate provided at a top part of said shaver main body, said supporting plate shielding said motor and drive mechanism from outside of said shaver main body and being provided with an attachment means for allowing said swingable cutter frames to be detachably attached to said supporting plate.

6. The rotary electric shaver according to claim 1, wherein
each of said swingable cutter frames is formed so that a cutter frame main body thereof is in a cylindrical shape, and
said cutter frame main body is formed with a plurality of slits which open at right angles with respect to an axial direction of said cutter frame main body and at a plurality of different positions in said axial direction of said cutter frame main body, said slits opening in mutually different directions at locations evenly separated from each other in a circumferential direction of said cutter frame main body.

7. The rotary electric shaver according to claim 1, wherein
each of said swingable cutter frames is formed so that a cutter frame main body thereof is in a substantially cylindrical shape, and
said cutter frame main body is formed with a slit which opens in a spiral shape.

8. The rotary electric shaver according to claim 1, wherein each of said swingable cutter frames is formed so that an intermediate part thereof in an axial direction of said cutter frame main body is a bellows having elasticity.

9. The rotary electric shaver according to claim 1, wherein each of said swingable cutter frames is formed so that a cutter frame main body thereof is comprised of two cutter frame sections divided in an axial direction of said cutter frame main body and said cutter frame sections are connected by an elastic member.

10. The rotary electric shaver according to any one of claims 6 to 9, wherein said each one of said swingable cutter frames is provided therein with a stopper for restricting a compression of said swingable cutter frame in an axial direction thereof.
